(19) United States
(12) Patent Application Publication
(10) Pub. No.: US 2010/0279685 A1
(43) Pub. Date: Nov. 4, 2010

(54) WIRELESS TERMINAL MANAGEMENT APPARATUS, WIRELESS TERMINAL MANAGEMENT METHOD, WIRELESS TERMINAL MANAGEMENT PROGRAM, AND RECORDING MEDIUM

(75) Inventors: Masaru Sasaki, Saitama (JP); Koichi Nagaki, Saitama (JP); Kenichi Takeda, Saitama (JP); Eiji Saito, Saitama (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/746,064

(22) PCT Filed: Dec. 4, 2007
(86) PCT No.: PCT/JP2007/073415

§ 371 Date: Jun. 18, 2010

(51) Int. Cl. H04W 60/00

(52) U.S. Cl. 455/435.1

(57) ABSTRACT

A wireless terminal management apparatus includes a communication unit performing short-distance wireless communication with wireless terminals; a registering unit that registers information indicating a wireless terminal connectable to the communication unit; a determining unit that determines whether the number of registrations of information indicating a wireless terminal registered in the registering unit has reached a given number of wireless terminals allowed to connect to the communication unit; an updating unit that when a non-registered wireless terminal is nearby and if the number of registrations has reached the given number, updates the number of registrations such that information indicating the non-registered wireless terminal becomes registered; and a searching unit that searches for a wireless terminal nearby, where if a search result indicates no registered wireless terminals and a non-registered wireless terminal nearby, the updating unit updates to enable information indicating the non-registered wireless terminal to be registered by the registering unit.

### TECHNICAL FIELD

The present invention relates to a wireless terminal management apparatus equipped on a mobile object such as a vehicle, a wireless terminal management method, a wireless terminal management program, and a recording medium. However, the present invention is not limited to the wireless terminal management apparatus, the wireless terminal management method, the wireless terminal management program, and the recording medium described above.

### BACKGROUND ART

Recently, a mobile object such as a vehicle is equipped with a navigation apparatus that searches for a route to a destination and guides the mobile object to the destination. A technology is known that can provide various services through a combination of such a navigation apparatus and a mobile phone terminal, wirelessly connected through a Bluetooth (registered trademark) device and by providing, for example, hands free communication and/or Internet connection (see, for example, Patent Document 1).

Patent Document 1: Japanese Patent Application Laid-Open Publication No. 2006-184103

### DISCLOSURE OF INVENTION

### Problem to be Solved by the Invention

However, the technology described in Patent Document 1 has an upper limit with respect to the number of mobile phone terminals (registered terminals) that can be registered for connection to the Bluetooth device. As a result, when a mobile phone terminal is newly registered after the upper limit has been reached, a user has to manually register the mobile phone terminal after deleting an unnecessary registered terminal. Thus, the technology has a problem of, for example, being troublesome and cumbersome for the user.

### Means for Solving Problem

To solve the problems above and achieve an object, a wireless terminal management apparatus according to one embodiment includes a communication unit that performs short-distance wireless communication with wireless terminal devices. The wireless terminal management apparatus further includes a registering unit that registers information indicating a wireless terminal device connectable to the communication unit; a determining unit that determines whether the number of registrations of information indicating a wireless terminal device registered in the registering unit has reached a given number of wireless terminal devices allowed to connect to the communication unit; an updating unit that when there is a non-registered wireless terminal device nearby and the determining unit determines that the number of registrations of information indicating a wireless terminal device has reached the given number, updates the number of registrations of information indicating a wireless terminal device registered in the registering unit such that information indicating the non-registered wireless terminal device can be registered; and a searching unit that searches for a wireless terminal device nearby. If a search result obtained by the searching unit indicates that there is no registered wireless terminal device and that there is a non-registered wireless terminal device, the updating unit updates the number of registrations such that information indicating the non-registered wireless terminal device can be registered, and causes the registering unit to register the information.

A wireless terminal management method according to another embodiment is a method for a wireless terminal management apparatus that includes a communication unit that performs short-distance wireless communication with a wireless terminal device. The wireless terminal management method includes registering information indicating a wireless terminal device connectable to the communication unit; determining whether the number of registrations of information indicating a wireless terminal device registered in the registering unit has reached a given number of wireless terminal devices allowed to connect to the communication unit; updating the number of registrations of information indicating a wireless terminal device registered in the registering unit, when there is a non-registered wireless terminal device nearby and at the determining, it is determined that the number of registrations of information indicating a wireless terminal device has reached the given number, the number of registrations of information being updated such that information indicating the non-registered wireless terminal device can be registered; and searching for a wireless terminal device nearby. If a search result obtained at the searching indicates that there is no registered wireless terminal device and that there is a non-registered wireless terminal device, the updating includes updating the number of registrations such that information indicating the non-registered wireless terminal device can be registered and causing the information to be registered at the registering.

A non-transitory computer-readable recording medium according to a further embodiment stores therein a wireless terminal management program that causes a computer to execute registering information indicating a wireless terminal device connectable to a communication unit that performs short-distance wireless communication with wireless terminal devices; determining whether the number of registrations of information indicating a wireless terminal device registered in the registering unit has reached a given number of wireless terminal devices allowed to connect to the communication unit; updating the number of registrations of information indicating a wireless terminal device registered in the registering unit, when there is a non-registered wireless terminal device nearby and at the determining, it is determined that the number of registrations of information indicating a wireless terminal device has reached the given number, the number of registrations of information being updated such that information indicating the non-registered wireless terminal device can be registered; and searching for a wireless terminal device nearby. If a search result obtained at the searching indicates that there is no registered wireless terminal device and that there is a non-registered wireless terminal device, the updating includes updating the number of registrations such that information indicating the non-registered wireless terminal device can be registered and causing the information to be registered at the registering.

A recording medium according to the invention of claim 9 stores therein the wireless terminal management program according to claim 8 so as to be read by the computer.

### BRIEF DESCRIPTION OF DRAWINGS

FIG. 1 is a block diagram of an exemplary functional configuration of a wireless terminal management apparatus according to an embodiment;

FIG. 2 is a flowchart of an exemplary procedure of wireless terminal management process performed by the wireless terminal management apparatus according to the embodiment;

FIG. 3 is a block diagram of an exemplary hardware configuration of a navigation apparatus according to an example;

FIG. 4 is a flowchart of an exemplary wireless terminal management process performed by the navigation apparatus according to the example; and

FIG. 5 is a diagram of an exemplary display of a notification screen for inquiring whether to delete a mobile phone terminal having the oldest history.

### EXPLANATIONS OF LETTERS OR NUMERALS

100 wireless terminal management apparatus
101 communication unit
102 registering unit
103 determining unit
104 updating unit
105 authenticating unit
106 acquiring unit
107 searching unit
108 receiving unit
109 notification control unit
300 navigation apparatus

### BEST MODE(S) FOR CARRYING OUT THE INVENTION

A preferred embodiment of a wireless terminal management apparatus, a wireless terminal management method, a wireless terminal management program, and a recording medium according to the present invention will be described with reference to the accompanying drawings.

### Embodiment

### Functional Configuration of Wireless Terminal Management Apparatus

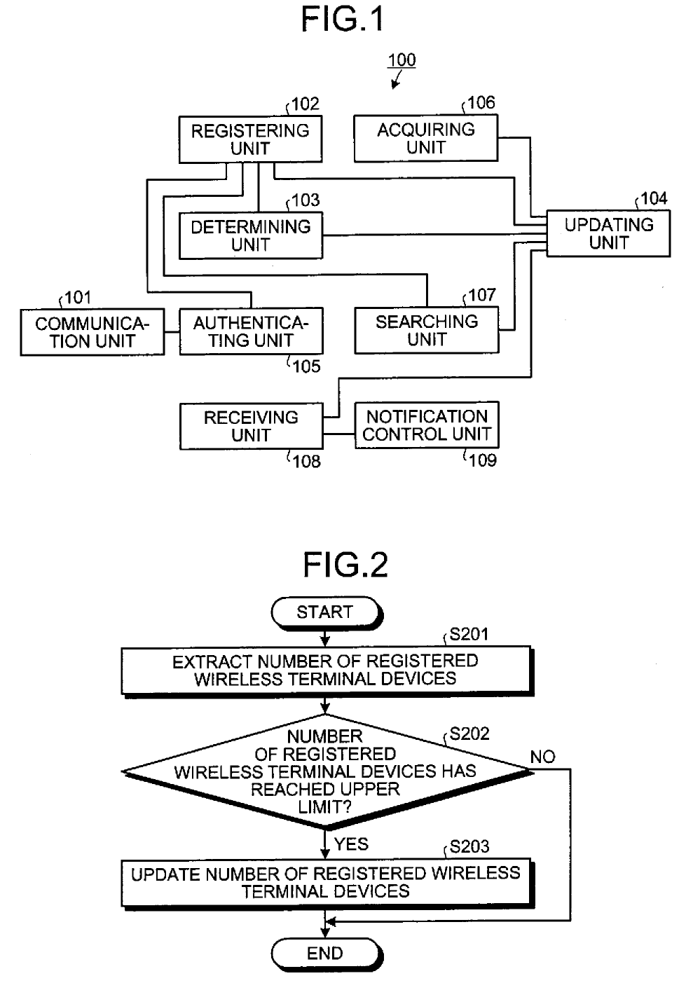

A functional configuration of a wireless terminal management apparatus 100 according to an embodiment of the present invention will be described. FIG. 1 is a block diagram of an exemplary functional configuration of the wireless terminal management apparatus 100 according to the embodiment.

As depicted in FIG. 1, the wireless terminal management apparatus 100 includes a communication unit 101, a registering unit 102, a determining unit 103, an updating unit 104, an authenticating unit 105, an acquiring unit 106, a searching unit 107, a receiving unit 108, and a notification control unit 109.

The communication unit 101 performs short-distance wireless communication with a wireless terminal device(s). The communication unit 101 is typically a Bluetooth device, but may be a device that transmits and receives data through infrared communication. “Bluetooth” is a registered trademark. The wireless terminal device is typically a mobile phone terminal, but may be another wireless terminal such as a PC that can perform short-distance wireless communication with the wireless terminal management apparatus 100 after registration.

The timing of connection to the wireless terminal device by the communication unit 101 is, for example, when the power is turned on and/or the user manually inputs an instruction to start the connection. The communication unit 101 has a function of initial communication to search for a wireless terminal device(s) nearby. The function of initial communication is not limited to the function of short-distance wireless communication, and may be another function of communication.

The registering unit 102 registers therein information indicating wireless terminal devices, a given number of which are allowed to be connected to the communication unit 101. The given number is set for each communication unit 101 in advance, and if the communication unit 101 is a Bluetooth device, for example, the given number is the number that can be registered with the Bluetooth device. Specifically, the registering unit 102 registers the wireless terminal device by correlating, for example, the device ID of the wireless terminal device and the ID of the Bluetooth device set for each device ID.

The determining unit 103 determines whether the number of registrations of information indicating wireless terminal devices (such as device IDs) registered in the registering unit 102 has reached the given number allowed to be connected to the wireless terminal management apparatus 100 (hereinafter, the number is called as an “upper limit”).

The updating unit 104 updates the number of registrations of information indicating wireless terminal devices registered in the registering unit 102 when the determining unit 103 determines that the number of registrations of information indicating wireless terminal devices has reached the upper limit. The update of wireless terminal devices means to change the number of registrations of information indicating wireless terminal devices that are have been registered (hereinafter, “registered”) such that information indicating a wireless terminal device that is not registered (hereinafter, “non-registered”) can be registered.

The authenticating unit 105 authenticates whether a wireless terminal device that performs short-distance wireless communication through the communication unit 101 is registered in the registering unit 102. Specifically, the authenticating unit 105 performs the authentication by using, for example, the device ID of the wireless terminal device and the ID of the Bluetooth device set for each device ID.

In the present embodiment, the acquiring unit 106 is an optional component. The acquiring unit 106 acquires history information that indicates the date of short-distance wireless communication with wireless terminal devices. Specifically, the history information is information indicating the dates of wireless terminal device connection. In this case, the updating unit 104 updates the number of registrations of information indicating wireless terminal devices registered in the registering unit 102, based on the history information acquired by the acquiring unit 106.

Specifically, the updating unit 104 may delete, from the registering unit 102, information indicating the wireless terminal device that has a history indicating the oldest date of connection in the past. This configuration deletes such information taking into consideration that such a wireless terminal device has a lower possibility of being connected in the future.

Alternatively, the updating unit 104 may delete, from the registering unit 102, information indicating the wireless terminal device(s) that has not been connected to the communication unit 101 for a given period of time. The period of time is a preset, and an arbitral period of time such as one month, three months, one year, etc., and may be changed by the input from the user. This configuration enables the registering unit 102 to register therein only frequently connected wireless terminal devices by deleting a wireless terminal device(s) that has not been connected for a given period of time and has a lower frequency of use.

In the present embodiment, the searching unit 107 is an optional component. The searching unit 107 searches for wireless terminal devices nearby. “Nearby” means, for example, within a radius of about 10 m. When the search result obtained by the searching unit 107 indicates that there is no registered wireless terminal device and that there is a non-registered wireless terminal device, the updating unit 104 updates the number of registrations such that information indicating the non-registered wireless terminal device can be registered, and causes the registering unit 102 to register the information.

However, the searching unit 107 cannot detect registered wireless terminal device(s) correctly when there is a wireless terminal device that, in view of security, does not respond to or responds only for a given period of time (for example, 3 minutes) to the searching unit 107 that searches for wireless terminal devices nearby. Taking into consideration the presence of such a wireless terminal device, when no response is obtained from registered wireless terminal device(s) in the search, the communication unit 101 tries a connection of short-distance wireless communication by Bluetooth.

In the present embodiment, the receiving unit 108 and the notification control unit 109 are optional components. The receiving unit 108 receives from the user, an instruction to update. The receiving unit 108 is implemented by operation buttons, a touch panel, a remote controller, etc. The notification control unit 109 issues a message asking the user whether to update, before the update is performed by the updating unit 104. Specifically, a message by the notification control unit 109 is visual and/or audible. In this case, the updating unit 104 updates the number of registrations if the receiving unit 108 receives an instruction to update in response to the message issued under the control of the notification control unit 109.

### (Procedure of Wireless Terminal Management Process Performed by Wireless Terminal Management Apparatus)

A procedure of wireless terminal management process performed by the wireless terminal management apparatus 100 will be described with reference to FIG. 2. FIG. 2 is a flowchart of an exemplary procedure of wireless terminal management process performed by the wireless terminal management apparatus 100 according to the present embodiment.

As depicted in the flowchart of FIG. 2, when a non-registered wireless terminal device is connected or detected nearby as a result of the search, the wireless terminal management apparatus 100 extracts the number of registrations of information indicating registered wireless terminal devices (step S201). Then, the wireless terminal management apparatus 100 determines whether the number of registrations of information indicating registered wireless terminal devices has reached the upper limit (step S202).

If the wireless terminal management apparatus 100 determines that the number of registrations of information indicating registered wireless terminal devices has reached the upper limit (step S202: YES), the wireless terminal management apparatus 100 updates the number of registrations such that information indicating the non-registered wireless terminal device can be registered (step S203) and registers the information indicating the non-registered wireless terminal device, and the sequence of processing ends.

On the other hand, if the wireless terminal management apparatus 100 determines that the number of registrations of information indicating registered wireless terminal devices has not reached the upper limit (step S202: NO), the wireless terminal management apparatus 100 registers the information indicating the non-registered wireless terminal device, and the sequence of processing ends. The information is registered by, for example, obtaining the device ID or the ID of the Bluetooth device from the wireless terminal device.

As described above, when a non-registered wireless terminal device is connected or detected and it is determined that the number of registrations of information indicating registered wireless terminal devices has reached the upper limit, the wireless terminal management apparatus 100 according to the present embodiment updates the number of registrations of information indicating registered wireless terminal devices such that the information indicating the non-registered wireless terminal device can be registered. Thus, the number of registrations of information indicating registered wireless terminal devices can be updated without involving cumbersome operation. Accordingly, the wireless terminal management apparatus 100, which can save the user the trouble of the update of wireless terminal devices, can be provided.

If the present embodiment is configured such that the number of registrations of information indicating registered wireless terminal devices is updated based on the history information of short-distance wireless communication with wireless terminal devices, the number of registrations of information indicating registered wireless terminal devices can be updated based on the date when the wireless terminal devices are connected.

If the present embodiment is configured such that the number of registrations is updated by deleting the information indicating the wireless terminal device that has a history indicating the oldest date of connection in the past, the wireless terminal device that has a lower possibility of being connected in the future can be removed without involving cumbersome operation.

If the present embodiment is configured such that the number of registration is updated by deleting information indicating the wireless terminal device(s) that has not been connected for a given period of time, the wireless terminal device(s) that has a lower frequency of use can be removed and only information indicating a frequently connected wireless terminal device(s) remains registered.

If the present embodiment is configured such that a non-registered wireless terminal device is registered when the result of the search indicates that there is no registered wireless terminal device and that there is a non-registered wireless terminal device, the information indicating the non-registered wireless terminal device can be registered without involving cumbersome operation.

If the present embodiment is configured such that the update of wireless terminal devices is performed after asking the user whether to update and receiving an instruction to update from the user before the update of the number of registrations, user intention can be reflected at each update, and the number of registrations can be easily updated and the information indicating the non-registered wireless terminal device can be easily registered.

### Example

An example of the present invention will be described below. In the following description, an example in which the wireless terminal management apparatus of the present invention is implemented by a navigation apparatus equipped on a vehicle is described.

### (Hardware Configuration of Navigation Apparatus)

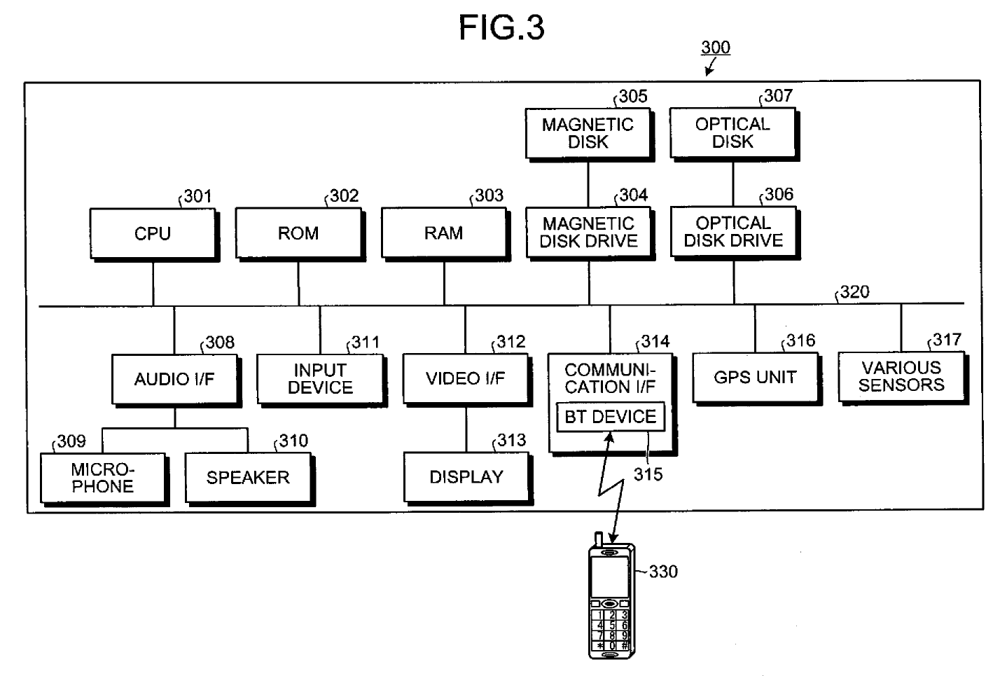

A hardware configuration of a navigation apparatus 300 according to the example will be described with reference to FIG. 3. FIG. 3 is a block diagram of an exemplary hardware configuration of the navigation apparatus 300 according to the example.

As depicted in FIG. 3, the navigation apparatus 300 is equipped on a mobile object such as a vehicle, and can perform short-distance wireless communication with a mobile phone terminal 330. The navigation apparatus 300 includes a CPU 301, a ROM 302, a RAM 303, a magnetic disk drive 304, a magnetic disk 305, an optical disk drive 306, an optical disk 307, an audio I/F (interface) 308, a microphone 309, a speaker 310, an input device 311, a video I/F 312, a display 313, a communication I/F 314, a Bluetooth (BT) device 315, a GPS unit 316, and various sensors 317. “Bluetooth” is a registered trademark. The components 301 to 317 are connected through a bus 320.

The CPU 301 governs overall control of the navigation apparatus 300. The ROM 302 stores therein various programs such as a boot program, a current position calculation program, a route search program, a route guidance program, and a wireless terminal management program. The RAM 303 is used as a work area of the CPU 301.

The current position calculation program causes calculation of the current position of the vehicle (the current position of the navigation apparatus 300) based on, for example, information output from the GPS unit 316 and the various sensors 317 described hereinafter.

The route search program causes retrieval of an optimal route from a start point to a destination with the use of map information, etc., recorded on the magnetic disk 305 described hereinafter. The optimal route is the shortest (or fastest) route to the destination or the most satisfying route for conditions specified by the user. The retrieved route is output to the audio I/F 308 and/or the video I/F 312 via the CPU 301.

The route guidance program causes generation of real-time route guidance information based on route guidance information retrieved by an execution of the wireless terminal management program, the current position information of the vehicle calculated by an execution of the current position calculation program, and the map data read out from the magnetic disk 305. The generated route guidance information is output to the audio I/F 308 and/or the video I/F 312 via the CPU 301.

The wireless terminal management program is a program that determines whether the number of registrations of device IDs or the IDs of the BT device 315 (hereinafter, “BTID”) of mobile phone terminals 330 connected to the BT device 315 has reached the upper limit, and if so, deletes the device ID(s) or the BTIDs of a registered mobile phone terminal(s) 330 based on the history information of short-distance wireless communication with mobile phone terminals 330.

The wireless terminal management program causes the communication I/F 314 described hereinafter to search for mobile phone terminals 330 nearby the navigation apparatus 300, and if the search result indicates that there is no device ID of a registered mobile phone terminal 330 and that there is a device ID of a non-registered mobile phone terminal 330, causes the device ID or the BTID of the non-registered mobile phone terminal 330 to be registered. The search by the communication I/F 314 is performed by, for example, requiring mobile phone terminals 330 nearby to transmit device IDs through the initial communication described above, and determining whether the respective device ID(s) of the mobile phone terminals 330 that have responded to the request is the device ID of a registered mobile phone terminal 330.

The magnetic disk drive 304 controls the reading and the writing of data with respect to the magnetic disk 305 under the control of the CPU 301. The magnetic disk 305 stores therein the data written under the control of the magnetic disk drive 304. The magnetic disk 305 may be HD (hard disk) or FD (flexible disk), for example. The magnetic disk 305 stores therein, for example, the device IDs or the BTIDs of registered mobile phone terminals 330, and also the date of short-distance wireless communication with mobile phone terminals 330 as history information for each device ID or the BTID of the mobile phone terminal 330.

The optical disk drive 306 controls the reading and the writing of data with respect to the optical disk 307 under the control of the CPU 301. The optical disk 307 is a removable recording medium from which data is read out under the control of the optical disk drive 306. A writable recording medium may be utilized for the optical disk 307. The removable recording medium may be a medium other than the optical disk 307, such as an MO, a memory card, etc.

The audio I/F 308 is connected to the microphone 309 and the speaker 310. The microphone 309 is arranged near the sun visor of the vehicle, and may be provided in plural. Sound received by the microphone 309 is A/D-converted within the audio I/F 308.

The speaker 310 outputs sound. Specifically, the speaker 310 outputs audible route guidance and/or the voice of a communication partner from the mobile phone terminal 330 during hands free communication. The input device 311 includes a remote controller having keys for entering characters, numeric values and various instructions, a keyboard, a mouse, a touch panel, etc. The input device 311 may be any one of the remote controller, the keyboard, the mouse, and the touch panel, or any combination thereof.

Using the input device 311, the user performs a delete operation for deleting the device ID, etc., of a registered mobile phone terminal(s) 330, an input operation for setting whether to delete the device ID, etc., of the registered mobile phone terminal(s) 330 automatically according to a given condition (ON/OFF setting), and an input operation of a password for authentication.

The video I/F 312 is connected to the display 313. Specifically, the video I/F 312 is made up of, for example, a graphic controller that generally controls the display 313, a buffer memory such as VRAM (Video RAM) that temporarily records immediately displayable image information, and a control IC that controls the display 313, based on image data output from a graphic controller.

The display 313 displays icons, cursors, menus, windows, or various data such as characters and images. For example, a CRT, a TFT liquid crystal display, a plasma display, etc., may be employed as the display 313. The display 313 is arranged, for example, near the dash board of the vehicle. On the display 313, a message for prompting registration of the device ID, etc., from the non-registered mobile phone terminal 330 and a notification for prompting a deletion of the device ID, etc., of a registered mobile phone terminal(s) 330 are displayed.

The communication I/F 314 is wirelessly connected to a network and functions as an interface between the navigation apparatus 300 and the CPU 301. The communication I/F 314 is wirelessly connected to a communication network such as the Internet and functions as an interface between the CPU 301 and the communication network.

The communication I/F 314 includes the BT device 315. The BT device 315 performs short-distance wireless communication with a mobile phone terminal(s) 330, and transmits/receives voice information during hands free communication and site information of the Internet. The BT device 315 utilizes, for example, a radio wave of 2.4 GHz, and communicates with an authenticated mobile phone terminal(s) 330 nearby within a radius of 10 m.

The GPS unit 316 receives signals from GPS satellites and outputs information indicative of the current position of the vehicle. The information output from the GPS unit 316 is used when the CPU 301 calculates the current position of the vehicle along with values output from the various sensors 317 described hereinafter. The information indicative of the current position is information specifying a point with respect to the map information, for example, latitude/longitude and altitude.

The various sensors 317 include a speed sensor, an acceleration sensor, and an angular-velocity sensor and output information that enables determination of position and behavior of the vehicle. The values output from the various sensors 317 are used by the CPU 301 for calculating the current position of the vehicle and measuring changes in speed and direction.

Functions of the communication unit 101, the registering unit 102, the determining unit 103, the updating unit 104, the authenticating unit 105, the acquiring unit 106, the searching unit 107, the receiving unit 108, and the notification control unit 109 included in the wireless terminal management apparatus 100 depicted in FIG. 1 are implemented by the CPU 301 executing predetermined programs to control the units of the navigation apparatus 300 with the use of programs and data recorded on the ROM 302, the RAM 303, the magnetic disk 305, the optical disk 307, etc., of the navigation apparatus 300 depicted in FIG. 3.

The navigation apparatus 300 of the example can execute the wireless terminal management program recorded on the ROM 302 serving as a recording medium in the navigation apparatus 300 to implement the function of the wireless terminal management apparatus 100 depicted in FIG. 1 in the procedure of the wireless terminal management process depicted in FIG. 2.

### (Exemplary Wireless Terminal Management Process Performed by Navigation Apparatus)

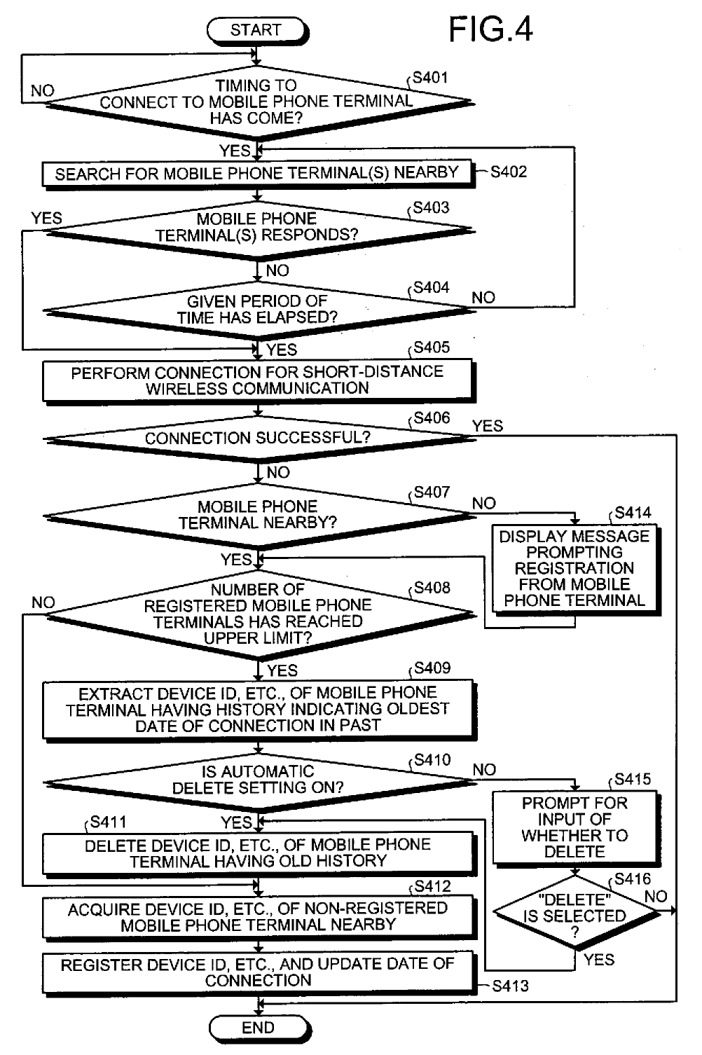

An exemplary wireless terminal management process performed by the navigation apparatus 300 according to the example will be described with reference to FIG. 4. FIG. 4 is a flowchart of an exemplary wireless terminal management process performed by the navigation apparatus 300 according to the example.

As depicted in FIG. 4, the navigation apparatus 300 determines whether a timing to connect to the mobile phone terminal 330 has come (step S401). The timing to connect to the mobile phone terminal 330 at step S401 is, for example, when the accessory power source is turned on or the navigation apparatus is turned on. The navigation apparatus 300 remains on standby at step S401 when the timing to connect to the mobile phone terminal 330 comes (loop from step S401: NO)

If the navigation apparatus 300 determines that the timing to connect to the mobile phone terminal 330 has come at step S401 (step S401: YES), the navigation apparatus 300 controls the communication I/F 314 to transmit a request for the device ID by initial communication, and searches for a registered mobile phone terminal(s) 330 nearby (step S402). Then, the navigation apparatus 300 determines whether a response has been received from a mobile phone terminal 330 in response to the request (step S403).

The navigation apparatus 300 determines, for example, whether the device ID, etc., of a mobile phone terminal 330 has been received from the mobile phone terminal 330 via the communication I/F 314. If the navigation apparatus 300 determines that no response has been received (step S403: NO), the navigation apparatus 300 determines whether a given period of time has elapsed from the request (step S404). This determination of whether the given period of time has elapsed is made, for example, taking into consideration a mobile phone terminal 330 that has a limited function of responding to the request for the given period of time.

If the navigation apparatus 300 determines that the given period of time has not elapsed (step S404: NO), the process returns to step S402 and the search is continued until the given period of time is elapsed. If the navigation apparatus 300 determines that the given period of time has elapsed (step S404: YES), the navigation apparatus 300 performs short-distance wireless communication by the BT device 315 (step S405). The navigation apparatus 300 tries to connect, for example, only to a mobile phone terminal 330 that was most recently connected among the registered mobile phone terminals 330 or to all of the registered mobile phone terminals 330 sequentially.

If a response from the mobile phone terminal 330 is received (step S403: YES), the process proceeds to step S405 and the navigation apparatus 300 makes a connection for short-distance wireless communication through the BT device 315. Then, the navigation apparatus 300 determines whether the connection for short-distance wireless communication with the registered mobile phone terminal(s) 330 is successful (step S406). If the navigation apparatus 300 determines that the connection is successful (step S406: YES), the sequence of processing ends. If the navigation apparatus 300 determines that the connection is not successful (step S406: NO), the navigation apparatus 300 determines whether there are any non-registered mobile phone terminals 330 nearby (step S407).

Whether the connection of short-distance wireless communication with the registered mobile phone terminal(s) 330 is successful can be determined, for example, by determining whether a reception of information such as the device ID, the device name, etc., from the mobile phone terminal(s) 330 is successful. Whether there are any non-registered mobile phone terminals 330 nearby can be determined by whether the device ID, the device name, etc., of the non-registered mobile phone terminal 330 is received during the search for a registered mobile phone terminal(s) 330 nearby or during the connection for short-distance wireless communication.

If the navigation apparatus 300 determines that there are not any non-registered mobile phone terminals 330 nearby (step S407: NO), the navigation apparatus 300 displays a message prompting the user for registration from the mobile phone terminal 330 (step S414). If the navigation apparatus 300 determines that there is a non-registered mobile phone terminal 330 nearby (step S407: YES), for example, a non-registered mobile phone terminal 330 is detected, the navigation apparatus 300 determines whether the number of registrations of registered mobile phone terminals 330 allowed to be connected to the BT device 315 has reached the upper limit (step S408).

After displaying the message prompting the registration from the mobile phone terminal 330 at step S414, the navigation apparatus 300 processes the registration performed by the mobile phone terminal 330. That is, the navigation apparatus 300 responds to a search for the navigation apparatus 300 performed by the mobile phone terminal 330, determines that there is a non-registered mobile phone terminal nearby at step S407 (step S407: YES), and performs the processing subsequent to step S408.

If the navigation apparatus 300 determines that the number of registrations of registered mobile phone terminals 330 has reached the upper limit (step S408: YES), the navigation apparatus 300 extracts the device ID, etc., of the mobile phone terminal 330 that has a history indicating the oldest date of connection in the past among the registered mobile phone terminals 330 (step S409). The processing at step S409 is not limited to extracting the mobile phone terminal 330 that has a history indicating the oldest date of connection in the past; alternatively, a mobile phone terminal(s) 330 that has not been connected for a given period of time may be extracted.

Then, the navigation apparatus 300 determines whether an automatic delete setting is ON (step S410). The automatic delete setting is a setting for deleting the device ID, etc. of a registered mobile phone terminal(s) 330 without any input from the user, and is set in advance and changed according to user instruction.

If the navigation apparatus 300 determines that the automatic delete setting is ON (step S410: YES), the navigation apparatus 300 deletes the device ID, etc., of the registered mobile phone terminal 330 having the oldest history (step S411). Then, the navigation apparatus 300 acquires the device ID, etc., from a non-registered mobile phone terminal 330 nearby (step S412). The device ID, etc., may be acquired from a memory into which the device ID acquired during the search or the connection for short-distance wireless communication described above is stored. Alternatively, the device ID, etc., may be acquired by transmitting a request therefor to the mobile phone terminal 330. Then, the navigation apparatus 300 registers, that is, writes the acquired device ID, etc., into the magnetic disk 305 and updates the date of connection (step S413), and the sequence of the processing ends.

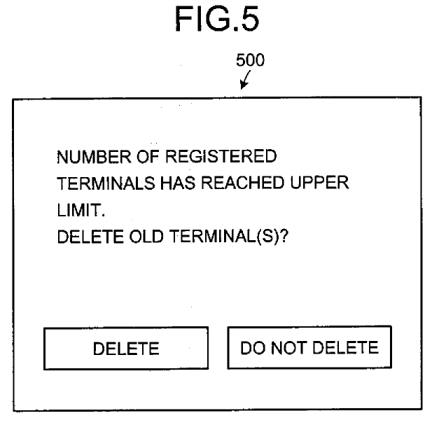

If the navigation apparatus 300 determines that the number of registrations of mobile phone terminals 330 allowed to be connected to the BT device 315 has not reached the upper limit (step S408: NO), the process proceeds to step S412. If the navigation apparatus 300 determines that the automatic delete setting is not ON (step S410: NO), that is, the automatic delete setting is OFF, the navigation apparatus 300 makes a notification for prompting the user to instruct whether to delete the information indicating the device ID, etc., of the mobile phone terminal 330 having the oldest history extracted at step S409 (step S415). The notification at step S415 is made by the display screen depicted in FIG. 5. The display screen depicted in FIG. 5 will be described later.

Thereafter, the navigation apparatus 300 determines whether “DELETE” has been selected by the user (step S416). If “DELETE” has been selected by the user (step S416: YES), the process proceeds to step S411. If “DO NOT DELETE” has been selected (step S416: NO), the sequence of processing ends. If “DO NOT DELETE” has been selected, a message informing the user that the non-registered mobile phone terminal 330 is not registered may be displayed.

### (Exemplary Display of Notification Screen for Inquiring Whether to Delete Mobile Phone Terminal Having Old History)

An exemplary display of a notification screen for inquiring whether to delete the mobile phone terminal having the oldest history will be described with reference to FIG. 5. FIG. 5 is a diagram of the exemplary display of the notification screen for inquiring whether to delete the mobile phone terminal having the oldest history. The notification screen depicted in FIG. 5 is a screen displayed at step S415.

As depicted in FIG. 5, the notification screen 500 notifies the user that the number of registrations of information indicating registered mobile phone terminals 330 has reached the upper limit, and prompts the user to instruct whether to delete the mobile phone terminal 330 having the oldest history. If “DELETE” is selected by the user in the notification screen 500, the information indicating the mobile phone terminal 330 that has a history indicating the oldest date of connection in the past is deleted as described above.

If “DO NOT DELETE” is selected by the user, the non-registered mobile phone terminal 330 is not registered and the current registration of mobile phone terminals 330 is maintained. The date of connection in the past may be displayed along with the notification for prompting the user to instruct whether to delete the mobile phone terminal 330 having the oldest history.

As described above, the navigation apparatus 300 according to the example updates the number of registrations of information indicating registered mobile phone terminals 330 if it is determined that the upper limit is reached. Thus, the number of registrations can be updated and the information indicating the non-registered mobile phone terminal 330 can be registered without involving cumbersome operation. Accordingly, the navigation apparatus 300, which can save the user the trouble of the update of mobile phone terminals 330, can be provided.

Further, in the example, the number of registrations of information indicating registered mobile phone terminals 330 is updated based on the history information of short-distance wireless communication with mobile phone terminals 330. Thus, the number of registrations can be updated or the device ID, etc., of the non-registered mobile phone terminal 330 can be registered by deleting the device ID, etc., of the registered mobile phone terminal(s) 330, based on the date of connection of the mobile phone terminals 330.

Further, in the example, the information indicating the mobile phone terminal 330 that has a history indicating the oldest date of connection in the past is deleted. Thus, the mobile phone terminal 330 that has a lower possibility of being connected in the future can be removed without involving cumbersome operation.

Further, if the example is configured such that the information indicating the wireless terminal device(s) that has not being connected for a given period of time is deleted, the wireless terminal device(s) that has a lower frequency of use can be removed and only information indicating a frequently connected mobile phone terminal(s) 330 remains registered.

Further, in the example, the number of registrations of information indicating registered mobile phone terminal 330 is updated and the information indicating the non-registered mobile phone terminal 330 is registered if the result of a search for registered mobile phone terminals 330 nearby indicates that there is no registered mobile phone terminal 330 and that there is a non-registered mobile phone terminal 330. Thus, a deletion of registration and a new registration can be performed without involving cumbersome operation.

Further, in the example, a notification is made to ask the user whether to update before the update of the number of registrations, and the number of registrations of registered mobile phone terminals 330 is updated if an instruction from the user to update is received. Thus, user intention can be reflected at each update, and the deletion of registration and the new registration can be easily performed.

As described above, according to the wireless terminal management apparatus, the wireless terminal management method, the wireless terminal management program, and the recording medium of the present invention, the deletion of registration and the new registration can be performed without involving cumbersome operation.

The wireless terminal management method described in the example may be implemented by executing a preliminarily prepared program, the program being executed by a computer such as a personal computer and a workstation. The program is recorded on a computer-readable recording medium such as a hard disk, a flexible disk, a CD-ROM, an MO, and a DVD and is read from the recording medium by the computer for execution. The program may be a transmission medium distributable through a network such as the Internet.

1-9. (canceled)

10. A wireless terminal management apparatus that includes a communication unit that performs short-distance wireless communication with wireless terminal devices, the wireless terminal management apparatus comprising:
a registering unit that registers information indicating a wireless terminal device connectable to the communication unit;
a determining unit that determines whether the number of registrations of information indicating a wireless terminal device registered in the registering unit has reached a given number of wireless terminal devices allowed to connect to the communication unit;
an updating unit that when there is a non-registered wireless terminal device nearby and the determining unit determines that the number of registrations of information indicating a wireless terminal device has reached the given number, updates the number of registrations of information indicating a wireless terminal device registered in the registering unit such that information indicating the non-registered wireless terminal device can be registered; and
a searching unit that searches for a wireless terminal device nearby, wherein
the updating unit, if a search result obtained by the searching unit indicates that there is no registered wireless terminal device and that there is a non-registered wireless terminal device, updates the number of registrations such that information indicating the non-registered wireless terminal device can be registered, and causes the registering unit to register the information.

11. The wireless terminal management apparatus according to claim 10, further comprising an acquiring unit that acquires history information that indicates a date of short-distance wireless communication with a wireless terminal device, wherein
the updating unit updates the number of registrations of information indicating a wireless terminal device registered in the registering unit, based on the history information acquired by the acquiring unit.

12. The wireless terminal management apparatus according to claim 11, wherein the updating unit deletes, from the registering unit, information indicating a wireless terminal device that has a history indicating the oldest date of connection in the past.

13. The wireless terminal management apparatus according to claim 11, wherein the updating unit deletes, from the registering unit, information indicating a wireless terminal device that has not been connected to the communication unit for a given period of time.

14. The wireless terminal management apparatus according to claim 10, further comprising:
a receiving unit that receives from a user, an instruction to update; and
a notification control unit that issues a message asking the user whether to update, before an update is performed by the updating unit, wherein
the updating unit updates the number of registrations if the receiving unit receives an instruction to update in response to the message issued under the control of the notification control unit.

15. A wireless terminal management method for a wireless terminal management apparatus that includes a communication unit that performs short-distance wireless communication with wireless terminal devices, the wireless terminal management method comprising:
registering information indicating a wireless terminal device connectable to the communication unit;
determining whether the number of registrations of information indicating a wireless terminal device registered in the registering unit has reached a given number of wireless terminal devices allowed to connect to the communication unit;
updating the number of registrations of information indicating a wireless terminal device registered in the registering unit, when there is a non-registered wireless terminal device nearby and at the determining, it is determined that the number of registrations of information indicating a wireless terminal device has reached the given number, the number of registrations of information being updated such that information indicating the non-registered wireless terminal device can be registered; and
searching for a wireless terminal device nearby, wherein
the updating, if a search result obtained at the searching indicates that there is no registered wireless terminal device and that there is a non-registered wireless terminal device, includes updating the number of registrations such that information indicating the non-registered wireless terminal device can be registered, and further includes causing the information to be registered at the registering.

16. A non-transitory computer-readable recording medium storing therein a wireless terminal management program that causes a computer to execute:
registering information indicating a wireless terminal device connectable to a communication unit that performs short-distance wireless communication with wireless terminal devices;
determining whether the number of registrations of information indicating a wireless terminal device registered in the registering unit has reached a given number of wireless terminal devices allowed to connect to the communication unit;
updating the number of registrations of information indicating a wireless terminal device registered in the registering unit, when there is a non-registered wireless terminal device nearby and at the determining, it is determined that the number of registrations of information indicating a wireless terminal device has reached the given number, the number of registrations of information being updated such that information indicating the non-registered wireless terminal device can be registered; and
searching for a wireless terminal device nearby, wherein
the updating, if a search result obtained at the searching indicates that there is no registered wireless terminal device and that there is a non-registered wireless terminal device, includes updating the number of registrations such that information indicating the non-registered wireless terminal device can be registered, and further includes causing the information to be registered at the registering.
